(19) United States
(12) Patent Application Publication
(10) Pub. No.: US 2013/0340407 A1
(43) Pub. Date: Dec. 26, 2013

(54) CLUSTERED, FIXED CANT, THROTTLEABLE ROCKET ASSEMBLY

(71) Applicants: David J. Fisher, Davis, CA (US); Gregory S. Mungas, Mojave, CA (US)

(72) Inventors: David J. Fisher, Davis, CA (US); Gregory S. Mungas, Mojave, CA (US)

(73) Assignee: FIRESTAR ENGINEERING, LLC, Mojave, CA (US)

(21) Appl. No.: 13/397,537

(22) Filed: Feb. 15, 2012

Related U.S. Application Data
(60) Provisional application No. 61/442,897, filed on Feb. 15, 2011.

(51) Int. Cl. F02K 9/00

(52) U.S. Cl. CPC F02K 9/00
USPC 60/204; 60/200.1

(57) ABSTRACT

A clustered, fixed cant, throttleable rocket assembly is used to propel and a steer a vessel in terrestrial or extraterrestrial applications. The fixed cant of each of at least three individual rockets in the cluster provides the steering input to the overall assembly. More specifically, by changing the propellant flow rate to the individual rocket engines relative to one another, the overall thrust vector of the rocket assembly may be selected to provide a desired steering input to the vessel. A measured vessel orientation may be compared with a desired vessel orientation to determine what steering input is required to achieve the desired vessel orientation.

### CROSS-REFERENCE TO RELATED APPLICATIONS

The present application claims benefit of priority to U.S. Provisional Patent Application No. 61/442,897, entitled “Clustered, Fixed Cant, Throttleable, Monopropellant Rocket Assembly” and filed on Feb. 15, 2011, which is specifically incorporated by reference herein for all that it discloses or teaches.

### GOVERNMENT LICENSE RIGHTS

This invention was made with government support under NNX10CC61P awarded by the National Aeronautics and Space Administration (NASA). The government has certain rights in the invention.

### BACKGROUND

Thruster or rocket engines intended to be used in vacuum or near vacuum environments (e.g., the Earth's upper atmosphere and space) or terrestrial environments utilize combustion and/or decomposition of stored fuel and oxidizer to produce thrust. The fuel and oxidizer may be stored separately and combined prior to combustion (i.e., a bipropellant) or premixed and stored prior to combustion (i.e., a monopropellant). While most rocket engines are internal combustion engines, other (e.g., decomposing-only) rocket engines also exist.

Many vehicles that utilize a rocket engine for thrust may require that overall thrust vector change over time. For example, as a vehicle consumes fuel and/or oxidizer, the center of mass of the vehicle changes. A change in the center of mass of the vehicle may change the required thrust vector to obtain a desired orientation of the vehicle. Further, unexpected conditions (e.g., environmental conditions) may affect the orientation of the vehicle and an adjustment of the thrust vector is required to correct the vehicle's orientation. Several systems and methods are currently used to vary a rocket engine's thrust vector.

For example, the entire rocket engine may be mounted on a hinge or gimbal, which selectively aims the thrust vector of the engine. Disadvantages to this system include the potential weight and complexity of the gimbal and associated actuators(s). Further, the propellant feed may need to be routed using low pressure flexible pipes and/or rotary couplings, which may not be as robust as rigid pipes and/or other connectors. These disadvantages are compounded for ascent vehicles that must efficiently and reliably overcome the force of gravity to be effective.

In another example, merely a combustion chamber and associated nozzle components of a rocket engine are gimbaled. Similar disadvantages to this system are the potential weight and complexity of the gimbal and associated actuator(s). However, the fuel/oxidizer pumps are fixed and high pressure feeds are attached to the gimbaled combustion chamber and nozzle components, which may improve reliability of the gimbaled combustion chamber and nozzle.

In yet another example, high-temperature vanes protrude into a rocket engine exhaust and are selectively tilted to deflect the exhaust jet to a desired vector. A disadvantage of this is that such vanes must able to reliably withstand very high temperatures and pressures.

In still another example, the rocket engine is fixed and attitude thrusters (e.g., Vernier thrusters) are used to steer a vehicle. Disadvantages to this system include the potential weight and complexity of the additional attitude thrusters.

### SUMMARY

Implementations described and claimed herein address the foregoing problems by providing a vessel including three or more rocket engines arranged in a cluster, wherein each rocket engine has a fixed cant with respect to a centerline of the vessel. The vessel further includes two or more control valves, each configured to control a propellant flow rate to one of the rocket engines, wherein adjusting the propellant flow rate to the rocket engines varies an overall thrust vector of the cluster of rocket engines.

Implementations described and claimed herein further address the foregoing problems by providing a method including adjusting a propellant flow rate to one or more of a cluster of three or more rocket engines, each with a fixed cant with respect to a centerline of a vessel, wherein adjusting the propellant flow rate to the rocket engines varies an overall thrust vector of the cluster of rocket engines.

Implementations described and claimed herein still further address the foregoing problems by providing a rocket engine cluster including three or more rocket engines, each with a fixed cant away from a centerline of the rocket engine cluster. The rocket engine cluster further includes three or more control valves, each configured to control a propellant flow rate to one of the rocket engines, wherein adjusting the propellant flow rate to the rocket engines varies an overall thrust vector of the rocket engine cluster.

Other implementations are also described and recited herein.

### BRIEF DESCRIPTIONS OF THE DRAWINGS

FIG. 1 is a perspective view of a vessel having an example clustered, fixed cant, throttleable rocket assembly.

FIG. 2 is an elevation side view of a vessel having an example clustered, fixed cant, throttleable rocket assembly.

FIG. 3 is a bottom view of a vessel having an example clustered, fixed cant, throttleable rocket assembly.

FIG. 4 is a flowchart illustrating an example propellant feed system for a clustered, fixed cant, throttleable rocket assembly.

FIG. 5 illustrates example operations for using a clustered, fixed cant, throttleable rocket assembly.

### DETAILED DESCRIPTIONS

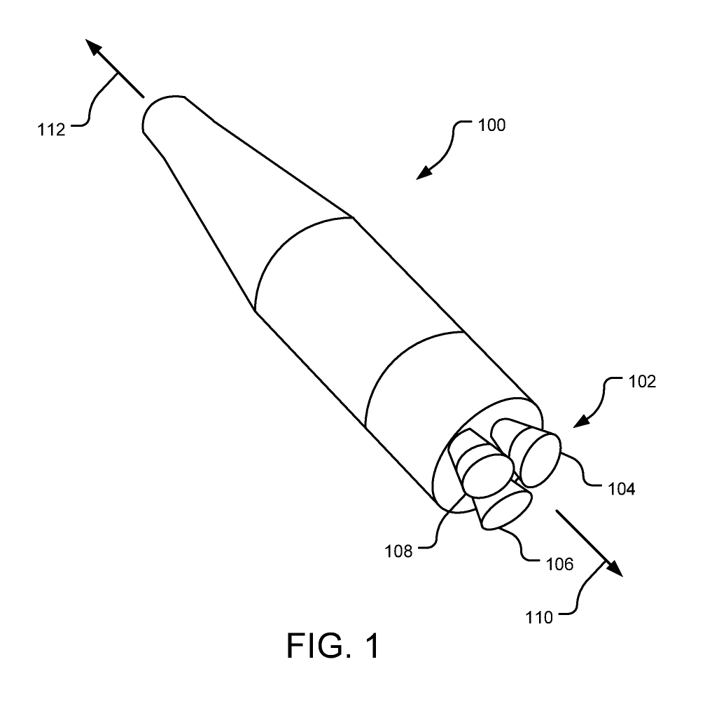

FIG. 1 is a perspective view of a vessel 100 having an example clustered, fixed cant, throttleable rocket assembly 102. The rocket assembly 102 converts combustion and/or decomposition of propellant, which may include fuel and oxidizer components into useable energy. More specifically, the rocket assembly 102 produces thrust by the expulsion of a high-speed fluid exhaust. This fluid is typically a gas, which is created by high pressure combustion and/or decomposition of the propellant within a combustion/decomposition chamber. The fluid exhaust is then passed through a cluster of supersonic propelling nozzles 104, 106, 108, which use heat energy of the gas to accelerate the exhaust to a supersonic or hypersonic speeds (as illustrated by arrow 110) and discharge the gas out of the nozzles 104, 106, 108. A resulting pressuring distribution produced by expansion of the combusting and/or decomposing propellant pressing on inside surfaces within each of the propelling nozzles 104, 106, 108 generates a net thrust, which causes the vessel 100 to be propelled in a direction generally opposite of the discharged propellant (as illustrated by arrow 112). In one implementation, the cluster of nozzles 104, 106, 108 is faster reacting than a singular nozzle that provides a similar magnitude of thrust.

The vessel 100 is configured to operate within one or more fluid and vacuum environments (e.g., planetary atmospheres, oceans, and space) Further, the vessel 100 may be part of a larger vessel (e.g., vessel 100 is a thruster on a space station). The propellant may be a monopropellant or bipropellant and individual components of the propellant (e.g., fuel and oxidizer) are stored in one or more tanks (not shown) within the vessel 100. Further, the supersonic propelling nozzles 104, 106, 108 may be of various types (e.g., de Laval, expansion-deflection, plug, aerospike, expanding, bell with a removable insert, stepped, dual-bell, dual-expander, dual-throat, and single expansion ramp).

The nozzles 104, 106, 108 are oriented such that the individual thrust vectors of each of the nozzles 104, 106, 108 provide a small moment arm relative to the vessel center of mass. As a result, each nozzle can generate a torque on the vessel 100 in order to provide pitch and yaw control for the vehicle 100. In one implementation, a 15 degree outward cant of each of the nozzles 104, 106, 108 is sufficient to provide pitch and yaw control for the vehicle 100. At a 15 degree outward cant, the vehicle's effective axial thrust and associated Iₛₚ is 96.4% of nominal, which is a favorable trade to gain attitude control using throttling of the nozzle outputs. In other implementations, more or less outward cant may be used. In various implementations, the nozzles 104, 106, 108 may be inwardly canted, outwardly canted, or not canted at all. For example, the nozzles 104, 106, 108 may have a small radial offset from the vehicle 100 center of gravity, which is sufficient to provide pitch and yaw control for the vehicle 100.

The outwardly directed thrust plumes from each of the nozzles 104, 106, 108 are designed such that interactions between the plumes under a variety of expected engine operating conditions do not adversely affect the ability to pitch/yaw control the vessel 100 or reduce overall axial thrust performance (e.g., grater than than 99% interaction). Further, engines associated with each of the nozzles 104, 106, 108 are each designed to operate within a range of chamber pressures where the flow exiting each engine is moving at local supersonic speeds. Since perturbations in a fluid stream propagate at the local speed of sound, which is slower than the plume velocity, disturbances associated with plume interactions downstream of the nozzles 104, 106, 108 do not propagate back upstream into the nozzles 104, 106, 108. This helps ensure that the shape of the pressure profile on the surfaces inside each engine and its corresponding nozzle is independent of downstream plume interactions. As a result, the thrust vector for each engine is fixed in a single direction. While the shape of the pressure profile may remain fixed inside a single engine, the amplitude of the pressure profile may increase or decrease as the engine is throttled. This supersonic flow design constraint with relatively weakly perturbed flows downstream of the nozzles 104, 106, 108 allows the magnitude of the thrust vector of a single engine to vary as the engine is throttled without changing the engine's thrust vector direction.

As the cant angles are increased, the axial thrust applied to the vessel 100 decreases. Therefore, arbitrarily large cant angles are undesirable because the cant angle reduces the effectiveness of the engines producing net axial thrust to the vessel 100.

With equal magnitude thrust vectors, the outward forces created by the nozzles 104, 106, 108 cancel out each other. Further, the orientation of each of the nozzles 104, 106, 108 may be permanently set (e.g., no mechanical actuators or gimbals are required). However, by throttling the rocket engines associated with each of the nozzles 104, 106, 108, the overall thrust vector (illustrated by arrow 112) may be manipulated to provide steering input to the vessel 100. A minimum of three nozzles is used to provide pitch/yaw control to the vessel 100. In some implementations, more than three nozzles may be used. Also, two nozzles may be used in an implementation that steers within a singular plane.

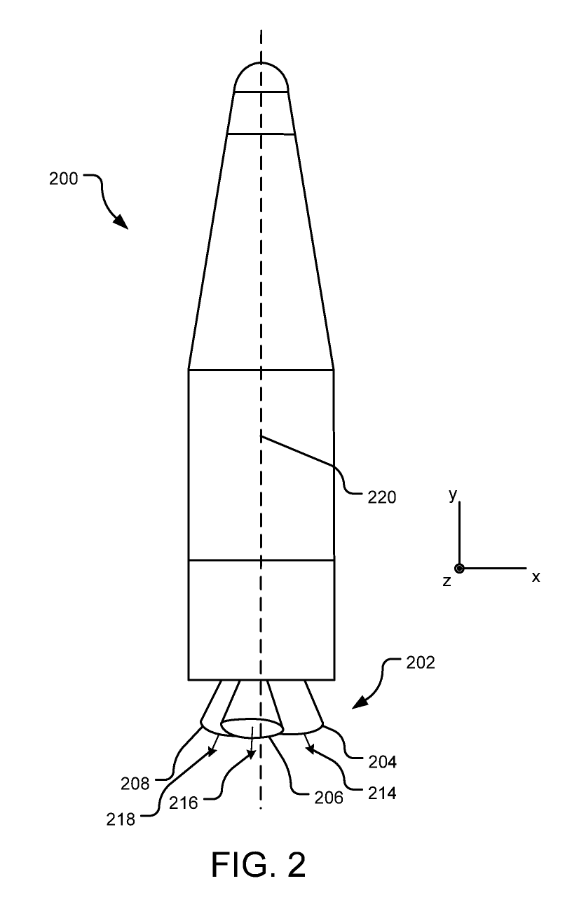

FIG. 2 is an elevation side view of a vessel 200 having an example clustered, fixed cant, throttleable rocket assembly 202. The rocket assembly 202 utilizes a cluster of nozzles 204, 206, 208 that direct the exhaust of high speed fluid flows. These fluid flows are typically generated from rocket combustion chambers that decompose and/or combust liquid and/or gas phase propellant to generate high temperature, high speed exhaust gases. This propellant may include fuel and oxidizer components.

For illustration purposes, the vessel 200 is oriented with a centerline 220 aligned with a y-axis. The magnitude of a thrust vector 214 associated with the nozzle 204 may be divided into a negative y-component, an x-component, and a negative z-component. The thrust vector 214 projects primarily in the negative y-direction, with a smaller magnitudes in the x-direction and the negative z-direction. The magnitude of a thrust vector 216 associated with the nozzle 206 may be divided into a negative y-component, a negative x-component, and a z-component. The thrust vector 216 projects primarily in the negative y-direction, with a smaller magnitudes in the negative x-direction and the z-direction. The magnitude of a thrust vector 218 associated with the nozzle 208 may be divided into a negative y-component, a negative x-component, and a negative z-component. The thrust vector 218 projects primarily in the negative y-direction, with a smaller magnitudes in the negative x-direction and the negative z-direction.

When the overall thrust vector (not shown) is aligned with the centerline 220, the x-component and z-components of the thrust vectors 214, 216, 218 cancel each other out. If the vessel 200 is to be steered in a desired direction, the magnitude of thrust vectors 214, 216, 218 is varied (e.g., by throttling the propellant input to one or more of the nozzles 204, 206, 208) so that the overall thrust vector projects in the x-component and z-component directions as the desired steering input to the vessel 200. When the overall thrust vector is not aligned with the centerline 220, the vessel 220 rotates in the x-component and z-component overall thrust vector direction, causing the vessel 200 to turn in the x-component and z-component direction of the overall thrust vector.

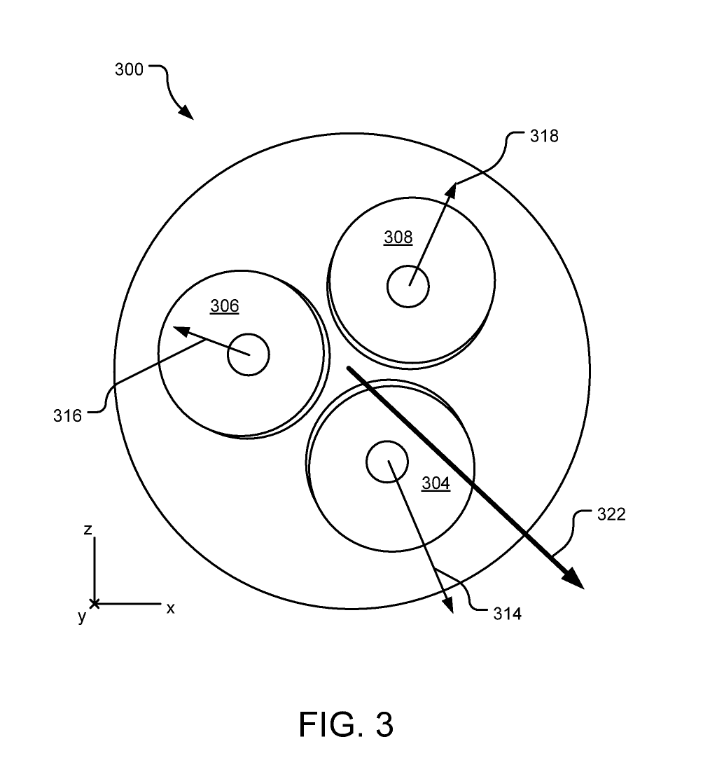

FIG. 3 is a bottom view of a vessel 300 having an example clustered, fixed cant, throttleable rocket assembly 302. The rocket assembly 302 utilizes a cluster of nozzles 304, 306, 308 that direct the exhaust of high speed fluid flows. These fluid flows are typically generated from rocket combustion chambers that decompose and/or combust liquid and/or gas phase propellant to generate high temperature, high speed exhaust gases. This propellant may include fuel and oxidizer components.

For illustration purposes, the vessel 300 is oriented with a centerline (not shown) aligned with a y-axis. The magnitude of a thrust vector 314 associated with the nozzle 304 may be divided into a negative y-component, an x-component, and a negative z-component. The thrust vector 314 projects primarily in the negative y-direction, with a smaller magnitudes in the x-direction and the negative z-direction. The magnitude of a thrust vector 316 associated with the nozzle 306 may be divided into a negative y-component, a negative x-component, and a z-component. The thrust vector 316 projects primarily in the negative y-direction, with a smaller magnitudes in the negative x-direction and the z-direction. The magnitude of a thrust vector 318 associated with the nozzle 308 may be divided into a negative y-component, an x-component, and a z-component. The thrust vector 318 projects primarily in the negative y-direction, with a smaller magnitudes in the x-direction and the z-direction.

An overall thrust vector 322 projects primarily in the negative y-direction, with a smaller magnitude in the x-direction and the negative z-direction. The overall thrust vector 322 is not aligned with the centerline of the vessel 300 because the magnitudes of the thrust vectors 316, 318, 320 are different from one another (as illustrated by the length of the arrows). This may be done purposefully to steer the vessel 300 (e.g., by throttling the propellant input to one or more of the nozzles 304, 306, 308). The thrust vector 314 has the greatest magnitude and the thrust vector 316 has the least magnitude. When the overall thrust vector 322 is not aligned with the centerline, the vessel 320 rotates in the x-component and z-component overall thrust vector 322 direction, causing the vessel 300 to turn in the x-component and z-component direction of the overall thrust vector 322.

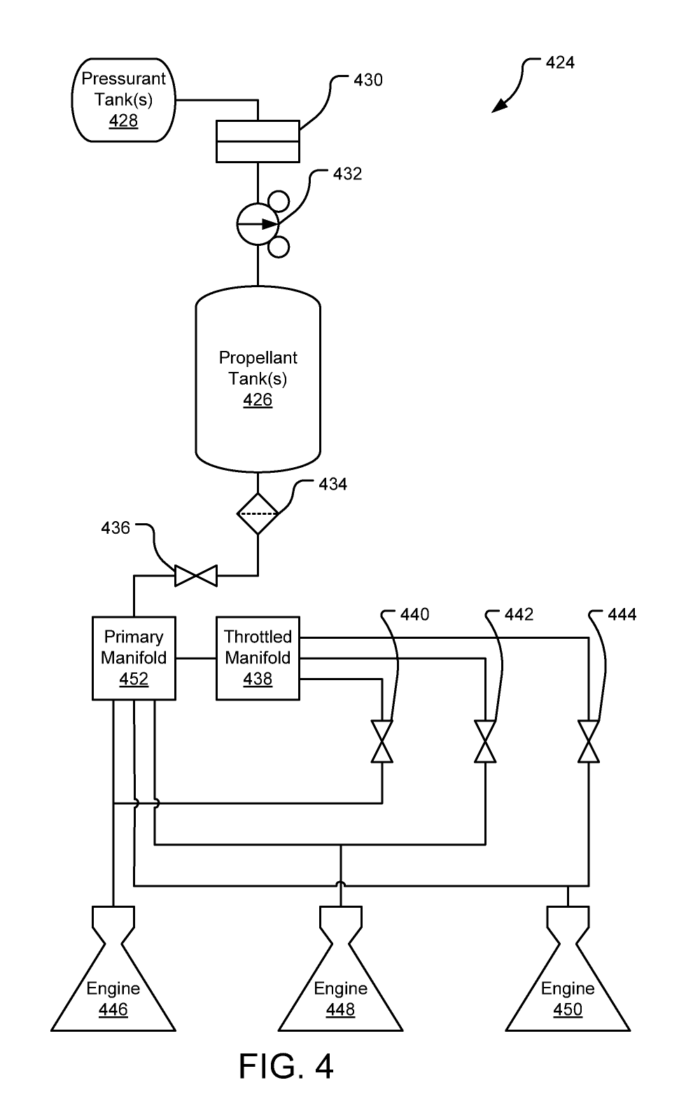

FIG. 4 is a flowchart illustrating an example propellant feed system 424 for a clustered, fixed cant, throttleable rocket assembly 402. The feed system 424 includes one or more propellant tanks 426. In a bipropellant system, the propellant tanks 426 each contain a fuel (e.g., hydrogen and kerosene) or an oxidizer (e.g., oxygen). In a monopropellant system, the propellant tanks 426 each contain a combination of the fuel and oxidizer (e.g., a nitrous oxide fuel blend, NOFBX™, hydrazine, hydrogen peroxide). Some systems may incorporate both monopropellant and bipropellant propellant tanks 426. For simplicity sake, FIG. 4 illustrates one propellant tank 426. In an example implementation, the propellant tank 426 is cylindrical with spherical ends and is a composite overwrapped pressure vessel (COPV) with an interior volume of 0.271 m³ storing a nitrous oxide fuel blend monopropellant. Other pressure vessel architectures are contemplated herein.

The propellant tanks 426 may be pressurized with one or more pressurant tanks 428 storing a high pressure inert fluid (e.g., Helium). The pressurant tanks 428 are connected to the propellant tanks 426 via a safety valve 430, a regulator valve 432, and one or more lines. For simplicity sake, FIG. 4 illustrates one pressurant tank 428. In one implementation, the pressurant tank 428 is a spherical COPV with an interior volume of 0.22 m³ storing Helium, the safety valve 430 is a redundant pyro-open pressurant valve (e.g., an EADS Astrium pyro valve), and the regulator valve 432 is a Moog 50-843.

In other implementations, the propellant tanks 426 are self pressurized (e.g., by the vapor pressure of the fluid therein) and no pressurant tanks are used. In one example implementation, heat from combustion/decomposition of the propellant is fed back to the propellant tanks 426 to aid pressurization of the propellant tanks 426. Further, a pump (not shown) may also be used to pressurize the propellant tanks 426.

Propellant discharged from the propellant tanks 426 is filtered by a filter 434 and controlled by a primary output valve 436. The filter 434 prevents any impurities and/or solid state phase portions of the propellant from proceeding downstream from the propellant tanks 426. The primary output valve 436 turns the propellant feed system 424 on and off. In an example implementations, the filter 426 is a Vacco F1D10691-01, the primary output valve 436 is a ¾″ electric actuated ball valve (e.g., a Moog 52-244), and lines connecting the filter 426 and primary output valve 436 to the propellant tanks 426 are ¾″ in outside diameter. In other implementations, the primary output valve 436 may be pyro-actuated, pneumatically actuated, or hydraulically actuated.

The propellant feeds into a primary manifold 452 that allows a relatively constant flow rate of the propellant to be fed to engines 446, 448, 450. Some variation in bulk flow rate through the primary manifold 452 may be caused by changing pressure and fluid conditions within the propellant tanks 426. The propellant is consumed within each of the engines 446, 448, 450 to produce thrust for a vessel (not shown). In one implementation, the engines 446, 448, 450 are each Firestar Technologies 2001bf Regeneratively Cooled NOFBX™ Thrusters. In some implementations, more than three engines may be used. Also, two engines may be used in an implementation that steers within a singular plane.

The propellant also feeds into a throttled propellant manifold 438 that distributes the propellant into three throttleable feed lines, each controlled by metering valves 440, 442, 444. The metering valves 440, 442, 444 provide the fine-tune throttling to the engines 446, 448, 450 to provide pitch/yaw control to the vessel. In one implementation, valves 440, 442, 444 may have a variable flow rate output controlled by changing the mechanical configuration of the valve (e.g., a flow control valve, a pintle valve, etc.). In another implementation, the valves 440, 442, 444 may be discrete on/off valves (e.g. latching valves, solenoid valves, etc.) that are operated in a pulse width modulated mode in order to vary flow rate through the valves 440, 442, 444.

The output propellant from the metering valves 440, 442, 444 is fed into the cluster of engines 446, 448, 450, respectively. The valves 440, 442, 444 are capable of metering additional amounts of propellant to each of the engines 446, 448, 450 in order to vary the relative thrust produced in each engine. In an example implementation, each of the feed lines input and output from the valves 440, 442, 444 are ⅜″ in outside diameter and each of the valves 440, 442, 444 are Moog 52-244 valves. In some implementations, there are redundant valves for each of latching valves 440, 442, 444 for safety purposes. Throttling the propellant flow rate through the feed lines using the valves 440, 442, 444 controls the overall thrust vector of the rocket assembly 402, which provides steering input to a vessel, as discussed above in detail.

As a result, the position of the valve sets 440, 442, 444 may be varied from fully closed to fully open without risking shutting down any of the engines 446, 448, 450. In one implementation, the input feed line to the primary manifold 452 is ⅜″ in outside diameter and each of the three output feed lines from the primary manifold 452 are 3/16″ in outside diameter. In this implementation, roughly 50% of the maximum propellant flow rate is provided by the primary manifold 452 with the remaining 50% of the maximum propellant flow rate provided by the throttled manifold 438. In other implementations, up to 99% of the maximum propellant flow rate is provided by the primary manifold 452 with the remaining 1% of the maximum propellant flow rate provided by the throttled manifold 438.

In some implementations, the primary manifold 452 is not included within the propellant feed system 424 and the throttled manifold 438 provides the entire flow rate of propellant. In this implementation, each of the valve sets 440, 442, 444 may have a minimum setting to prevent shutting down any of the engines 446, 448, 450.

In an example implementation, the aforementioned propellant feed system 424 for and the clustered, fixed cant, throttleable rocket assembly 402 is attached to a 2670N thrust, 250 kg vehicle with a 2.56 m overall length and 56 cm maximum diameter. The rocket assembly 402 may be used to launch the vehicle from the surface of Mars and achieve 4,157 m/s velocity, sending the vehicle into a 500 km altitude circular low-Mars orbit.

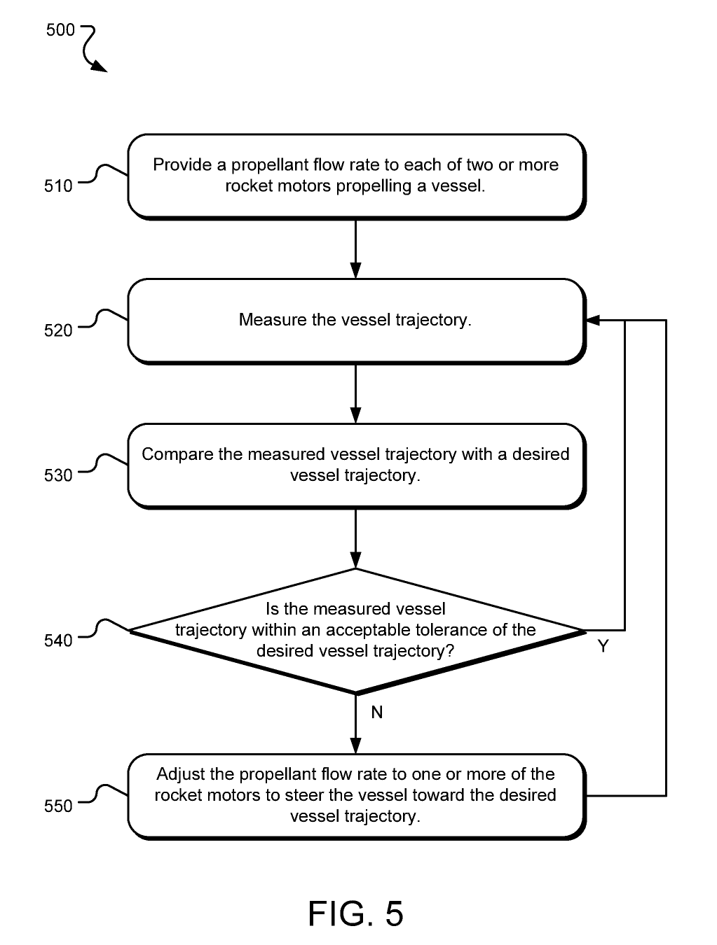

FIG. 5 illustrates example operations 500 for using a clustered, fixed cant, throttleable rocket assembly. A providing operation 510 provides a propellant flow rate to each of a cluster of two or more rocket motors propelling a vessel. The rocket motors have a fixed outward cant or other orientation that applies a moment arm to the vessel to provide pitch/yaw steering of the vessel by varying the propellant flow rates to the motors. In one implementation, the propellant flow rate to each of two or more rocket motors is initially equal. Further, three rocket motors is the minimum required to provide 2-axis steering of the vessel.

A measuring operation 520 measures the vessel orientation. The measuring operation may be accomplished using equipment onboard the vessel or external equipment monitoring the vessel or any combination thereof (e.g., attitude-monitoring, altitude-monitoring, satellite positioning, etc.). A comparing operation 530 compares the measured vessel orientation with a desired vessel orientation. The comparing operation 530 may be performed onboard the vessel or external to the vessel.

A decision operation 540 determines whether the measured vessel orientation is within an acceptable tolerance of the desired vessel orientation. If so, the measuring operation 520 repeats. In an example implementation, the acceptable tolerance of the desired vessel orientation is a 5% deviation. If the decision operation 540 determines that the measured vessel orientation is outside the acceptable tolerance of the desired vessel orientation, adjusting operation 550 adjusts the propellant flow rate to one or more of the rocket motors to steer the vessel toward the desired vessel orientation. The adjusting operation 550 modifies the thrust vector to rotate the vessel toward the desired vessel orientation.

Iterative repetition of the operations 520, 530, 540, 550 may achieve and maintain the desired vessel orientation. Further, the operations 500 may be a part of an automated control feedback system that automatically adjusts the propellant flow rates to maintain a desired vessel orientation. In other implementations, some or all of the operations 500 are performed manually.

The operations making up the embodiments of the invention described herein may be performed in any order, adding or omitting operations, unless explicitly claimed otherwise or a specific order is inherently necessitated by the claim language. The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A vessel comprising:
three or more rocket engines arranged in a cluster, wherein each rocket engine has a fixed cant with respect to a centerline of the vessel; and
two or more control valves, each configured to control a propellant flow rate to one of the rocket engines, wherein adjusting the propellant flow rate to the rocket engines varies an overall thrust vector of the cluster of rocket engines.

2. The vessel of claim 1, wherein each of the three or more rocket engines cant away from the centerline of the vessel.

3. The vessel of claim 1, wherein the cants of each of the three or more rocket engines are equal in magnitude.

4. The vessel of claim 1, wherein the cants of each of the three or more rocket engines are approximately 15 degrees.

5. The vessel of claim 1, wherein the sum of the cants of each of the three or more rocket engines in directions perpendicular to the centerline of the vessel is approximately zero.

6. The vessel of claim 1, wherein equal propellant flow rate to each of the three or more rocket engines creates a thrust vector substantially aligned with the centerline of the vessel.

7. The vessel of claim 1, further comprising:
a feedback control circuit that iteratively varies the overall thrust vector of the cluster of rocket engines to achieve a desired vessel orientation.

8. The vessel of claim 1, wherein greater than 99% of the mass flow rate output from each of the rocket engines interacts with the mass flow rate output of another of the cluster of rocket engines.

9. A method comprising:
adjusting a propellant flow rate to one or more of a cluster of three or more rocket engines, each with a fixed cant with respect to a centerline of a vessel, wherein adjusting the propellant flow rate to the rocket engines varies an overall thrust vector of the cluster of rocket engines.

10. The method of claim 9, wherein each of the three or more rocket engines cant away from the centerline of the vessel.

11. The method of claim 9, wherein the cants of each of the three or more rocket engines are equal in magnitude.

12. The method of claim 9, wherein the cants of each of the three or more rocket engines are approximately 15 degrees.

13. The method of claim 9, wherein the sum of the cants of each of the three or more rocket engines in directions perpendicular to the centerline of the vessel is approximately zero.

14. The method of claim 9, wherein equal propellant flow rate to each of the three or more rocket engines creates a thrust vector substantially aligned with the centerline of the vessel.

15. The method of claim 9, further comprising:
comparing a measured vessel attitude with a desired vessel orientation, wherein the adjusting operation is performed to align the measured vessel orientation with the desired vessel orientation.

16. The method of claim 15, wherein the comparing and adjusting operations are performed iteratively to align the measured vessel orientation with the desired vessel orientation.

17. The method of claim 9, wherein greater than 99% of the mass flow rate output from each of the rocket engines interacts with the mass flow rate output of another of the cluster of rocket engines.

18. A rocket engine cluster comprising:
three or more rocket engines, each with a fixed cant away from a centerline of the rocket engine cluster; and
three or more control valves, each configured to control a propellant flow rate to one of the rocket engines, wherein adjusting the propellant flow rate to the rocket engines varies an overall thrust vector of the rocket engine cluster.

19. The rocket engine cluster of claim 18, wherein the sum of the cants of each of the three or more rocket engines in directions perpendicular to the centerline of the rocket engine cluster is approximately zero.

20. The rocket engine cluster of claim 18, further comprising:
a feedback control circuit that iteratively varies the overall thrust vector of the cluster of rocket engines to achieve a desired vessel orientation.
